(19) United States
(12) Patent Application Publication
(10) Pub. No.: US 2010/0146289 A1
(43) Pub. Date: Jun. 10, 2010

(54) RADIO SCENE ENCRYPTION AND AUTHENTICATION PROCESS

(76) Inventors: Theodoros Kamakaris, Jersey City, NJ (US); Patrick White, Bernardsville, NJ (US)

Correspondence Address: GREENBERG TRAURIG, LLP, 200 PARK AVE., P.O. BOX 677, FLORHAM PARK, NJ, 07932, US

(21) Appl. No.: 12/608,319

(22) Filed: Oct. 29, 2009

Related U.S. Application Data
(60) Provisional application No. 61/109,677, filed on Oct. 30, 2008.

(51) Int. Cl. H04L 9/32

(52) U.S. Cl. 713/180; 380/270; 380/263

(57) ABSTRACT

A method is provided for encryption/decryption for secure the privacy of the information flow between two communicating nodes, and authentication to establish the identity of the communicating nodes in digital communications systems. A common secret or encryption key is generated at the two nodal ends of the communication link without prior dissemination. The authenticity of the communicating entities are maintained over time based on unique non-idealities of the communicating nodes in conjunction with the propagation characteristics of a link between them.

### CROSS-REFERENCE TO RELATED APPLICATIONS

The present application claims the benefit of U.S. Provisional Patent Application Ser. No. 61/109,677, filed on Oct. 30, 2008, the disclosure of which is incorporated herein by reference in its entirety.

### STATEMENT REGARDING FEDERALLY SPONSORED RESEARCH

Some of the research performed in the development of the disclosed subject matter was supported by U.S. government Grant Nos. W15QkN-05-D-0011/FA8240-07-R-0035. The U.S. government may have certain rights with respect to this application.

### FIELD OF THE INVENTION

The present invention relates to a system for encryption and authentication in digital communications, and, more particularly, to a system for encryption and authentication utilizing unique characteristics of a communications channel.

### BACKGROUND OF THE INVENTION

Since the pioneering of wireless data transmission more than a century ago, exhaustive research has been focused on improving the capacity of the wireless channel while maintaining robustness. Various modulation schemes and advances in RF design address these issues at the physical layer, yet the security aspect of the wireless network is usually left as an afterthought, to be handled at higher layers with cryptography.

When considering the security of a wireless network, the two major issues that must be considered are access control and privacy assurance. Access is restricted to authorized users by the use of various authentication mechanisms that verify the user's identity. Privacy of the data communicated in the network is protected by cryptography. Although these two aspects of security can be examined independently from each other, vulnerability in one of the two security mechanisms will almost definitely expose the other.

Authentication mechanisms depend on some form of handshaking between the client and a server, transferring sensitive information over the open channel. Interception of such information would allow a rogue client to gain access to the network, and, therefore, intricate mechanisms must ensure the privacy of the handshake, often allowing for security holes. Cryptographic mechanisms are based on a key that will allow encryption and decryption of data at the two ends of the channel. This key can be preordained or distributed upon connection. Both options have vulnerabilities that can be exploited.

### SUMMARY OF THE INVENTION

The present invention overcomes the disadvantages and shortcomings discussed above by providing a system that offers a number of advantages over the prior art. For example, although the aforestated security problems exist in any network, wired or wireless, mobility, an attribute inherently associated with wireless networks, requires that the communications channel is available in the entire covered area, making it easier for an unauthorized client to monitor communications or impersonate an authorized user. There is however a feature of a wireless channel that may be used as a security advantage. The characteristics of the communications channel have unique features that can only be determined by the two ends of the channel.

Experimental data has indicated that the characteristics of the channel are dynamic enough spatially to be used to differentiate between users that are close to each other, while at the same time static enough temporally to ensure the same key can be generated with one or multiple packet exchanges. Generating an encryption key on-the-fly at both ends independently significantly reduces overhead and risk associated with current key distribution techniques.

This novel process for generating encryption keys eliminates dissemination overhead and security risks of pre-shared keys. Furthermore, it significantly simplifies point-to-point encryption for complex topology networks, providing “low cost” security to emerging adhoc networks (vehicular, sensor, military). It provides transparent security for Local Area Network (LAN) and Personal Area Network (PAN) applications, and is an ideal security solution for emerging Ultra-Wide Band (UWB) systems. United States Department of Defense (DOD) applications can benefit from uncorrelated fast re-keying that can be achieved in fast changing environments for provably secure communications with no cost re-keying. Finally, the process facilitates innovative access control mechanisms based on Transmit-Receive signatures, as well as intrusion detection capabilities.

More particularly, the present invention provides a method for encryption/decryption and authentication during forward and reverse path communications for data between a transmitter frontend and a receiver frontend on a link between a first transceiver and a second transceiver. The method comprises the steps of determining a channel response having independent information bits for the link; and determining a propagation signature from the independent information bits extracted from the channel response, whereby the propagation signature is used as a symmetric key with which the data is encrypted/decrypted. The method also comprises the steps of determining a transmit-receive frequency response having independent information bits for the forward path communications for the transmitter and receiver frontends, and determining a transmitter-receiver signature from the independent information bits extracted from said transmit-receiver frequency response for the forward path communications, whereby the transmitter-receiver signature is used by the receiver as an authentication mask for identifying the transmitter together with the propagation signature. Likewise, the method also comprises the steps of determining a transmit-receive frequency response having independent information bits for the reverse path communications for the transmitter and receiver frontends; and determining a transmitter-receiver signature from the independent information bits extracted from the transmit-receiver frequency response for the reverse path communications, whereby the transmitter-receiver signature is used by the receiver as an authentication mask for identifying the transmitter together with said propagation signature.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a schematic diagram showing a transmitter-receiver pair of communication nodes transmitting data over a communication link;

FIG. 2 is a flow diagram depicting a signature generation method, starting with the channel estimate as provided by a typical Orthogonal Frequency Division Multiplexing (OFDM) system and generating the signatures along with associated statistics for one embodiment of the present invention;

FIG. 3 is flow diagram illustrating a key negotiation protocol for two nodes to establish an encrypted link and periodically update the symmetric key;

FIG. 4 is a graph showing the functional relationship of signature tracking in terms of information bits over time;

FIGS. 5a-5d are graphs displaying experimental results of propagation signature extraction and information bits achievable from measurements in an indoor environment across varying locations; and

FIGS. 6a-6e are graphs displaying experimental results of transmitter-receiver signature extraction and information bits achievable from measurements across multiple different transmitter-receiver pairs for a particular manufacturer.

### DETAILED DESCRIPTION OF THE INVENTION

Encryption is commonly employed in digital communication systems in order to secure the privacy of the information flow. Authentication serves the purpose of establishing the identity of the communicating nodes within the context of access control, auditing and non-repudiation. The two processes are commonly based on one or more shared secrets between the two communicating nodes. Symmetric cryptographic schemes require a shared secret to be disseminated through a secure information channel prior to its use. The present invention provides a novel method of generating the common secret at the two ends of a communication link without prior dissemination. Furthermore the invention provides a method to maintain the authenticity of the communicating entities over time based on the unique non-idealities of the transceivers in conjunction with the propagation characteristics of the link.

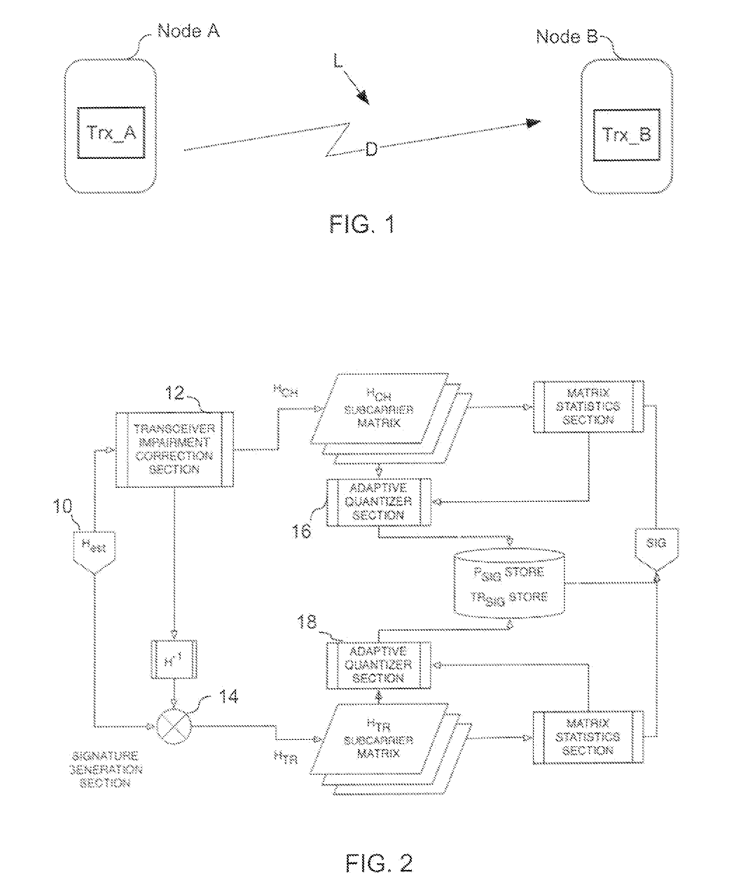

FIG. 1 illustrates a pair of digital communication nodes A and B, in which node A has a transceiver A (Trx_A) and node B has a transceiver B (Trx_B). The nodes A and B transmit data D over a communication channel or link L. The data D, which includes all media (e.g., voice, etc.), is securely transmitted using common secret or encryption keys based on signatures.

The encryption keys are generated during the communication process at both ends of the link L (i.e., the transceiver A (Trx_A) and the transceiver B (Trx_B pair)) without any a-priori knowledge. More particularly, the process utilizes the unique characteristics of the channel L (i.e., a channel response) between the transceiver A (Trx_A) and the transceiver B (Trx_B) as a common secret measurable only between the communicating nodes, to generate the encryption keys that are used by conventional cryptographic mechanisms. The channel response is a complex product of the various propagation phenomena that contribute to the received signal power. The estimation of the channel response, the multipath profile, the frequency selective fading etc., provides statistical information that is common for the two ends of the channel but unknown to everybody else. For example, the frequency response measured across the communications link L represents a convolution of the propagation channel and the transceiver impairments. Both features represent unique characteristics identifying a specific transceiver at a specific location. The convolved features are separated into Transmit-Receive and Propagation Signatures that can be used as a shared secret across the link for encryption and authentication. Such signatures rely on the joint information across the transmitter-receiver pair and are not stationary, rendering estimation and spoofing difficult. Channel estimation (i.e., the estimation of the deterministic relationship between the transmitted and the received signal), currently used in many communication systems, is used to define these characteristics periodically or on a per packet basis

Referring to FIG. 2, a process for generating encryption keys on-the-fly at both ends of a channel between a transmitter-receiver pair is illustrated. The algorithms described hereinbelow are based on nodes A and B which utilize Orthogonal Frequency Division Multiplexing (OFDM) based transceivers A (Trx_A) and transceiver B (Trx-B) that are operating in Time Division Duplex (TDD) mode. The transceiver A (Trx_A) and transceiver B (Trx-B) implement time and frequency synchronization and channel equalization through known techniques (e.g., cyclic prefix synchronization, pilot based channel estimation, etc.) that are applicable to OFDM systems. The method depends on algorithms that extract the uniqueness of the examined characteristics and consider the temporal stability of the channel. It is noted, however, that equivalent algorithms may be developed for communication systems that utilize other modes of operation.

The algorithms used in the process are described hereinbelow. More particularly, the algorithms used in the creation of a symmetric key (SIG) are described in relation to FIG. 2. More particularly, SIG is determined based on Hₑₛₜ (see block 10 in FIG. 2) as follows:
The frequency response (H_{AB}) estimated across a forward path transmission from transceiver A (Trx_A) to transceiver B (Trx_B) can be expressed in the frequency domain as the product of three components H_{AB}=I_{A}^{TX}×H_{CH}×I_{B}^{RX}, where:
a. I_{A}^{TX} is the frequency response of transmitter frontend A as measured from the Modulated Information Bits to the Trx_A antenna port;
b. H_{CH} is the frequency response from Trx_A antenna port to Trx_B antenna port; and
c. I_{B}^{RX} is the frequency response of receiver frontend B as measured from Trx_B antenna port to the Demodulated Information Bits.
Likewise defined H_{BA}=I_{B}^{TX}×H_{CH}×I_{A}^{RX} represents the reverse path.
Reference is made to H_{CH} as the Channel Response of the link, which is common for both paths from the channel symmetry axiom, while I_{A}^{TX}×I_{B}^{RX} or I_{A}^{TX}×I_{B}^{RX} for the forward and reverse paths respectively we define as the Transmit-Receive Response (H_{TR}) of each path, noting that H_{TR}^{AB} and H_{TR}^{BA} are different due to different transceiver imperfections across the Receive and Transmit Paths.
H_{CH} is estimated at block 12 (i.e., transceiver impairment correction section) through known frequency offset and I/Q imbalance correction techniques, allowing the calculation of H_{TR} at block 14 (i.e., H_{TR} is the outcome of the multiplier (X) with input Hest and H⁻¹, where H⁻¹ indicates the inverse of the channel estimate H_{CH}).
Independent information bits are extracted from H_{CH} as a Propagation signature (P_{SIG}) independently at each receiver through the signature generation method which is illustrated at step 16 (i.e., adaptive quantizer section).
Independent information bits are extracted from H_{TR} as a Transmitter-Receiver signature (TR_{SIG}) at each receiver through the signature generation method illustrated at step 18 (adaptive quantizer section).
The same P_{SIG} is independently calculated at each Transceiver with one or multiple packet exchanges and used as a symmetric key with which data is encrypted and decrypted via known symmetric cryptography schemes.
P_{SIG} is periodically recalculated and can optionally update the key used for encryption as often as the Channel Response changes.
A different TR_{SIG} for each Transmitter is calculated by each Receiver and used as the authentication mask identifying the Transmitter together with the P_{SIG}.

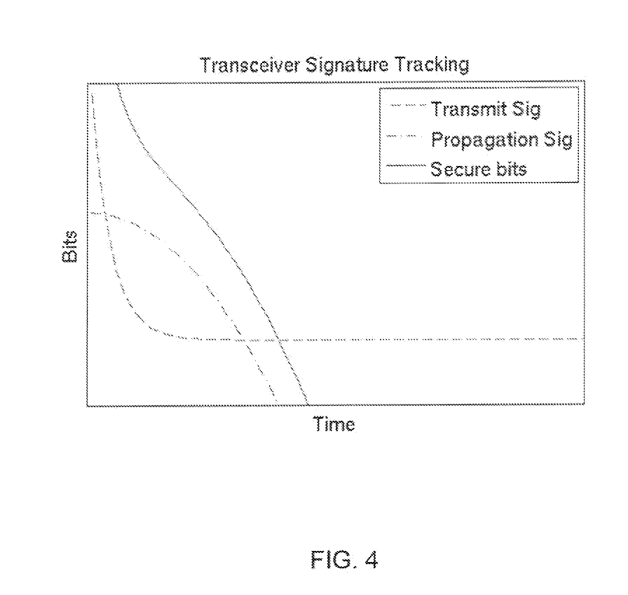

Referring to FIG. 4, both signatures change over time at different time scales. A signature tracking method is used to maintain authentication of a communicating transceiver while allowing for the encryption key to change. If the combined signatures do not achieve the required information bits then re-authentication is necessary. This method will timeout whenever the communication link has been idle and the signatures diverge, but also will prevent possible session takeover attempts by rogue transceivers. There is a small time window during which the TR_{SIG} can be spoofed with high accuracy after every transmitted packet, however the receiver expects the P_{SIG} to stay constant within that window and therefore can detect a spoofed transmission.

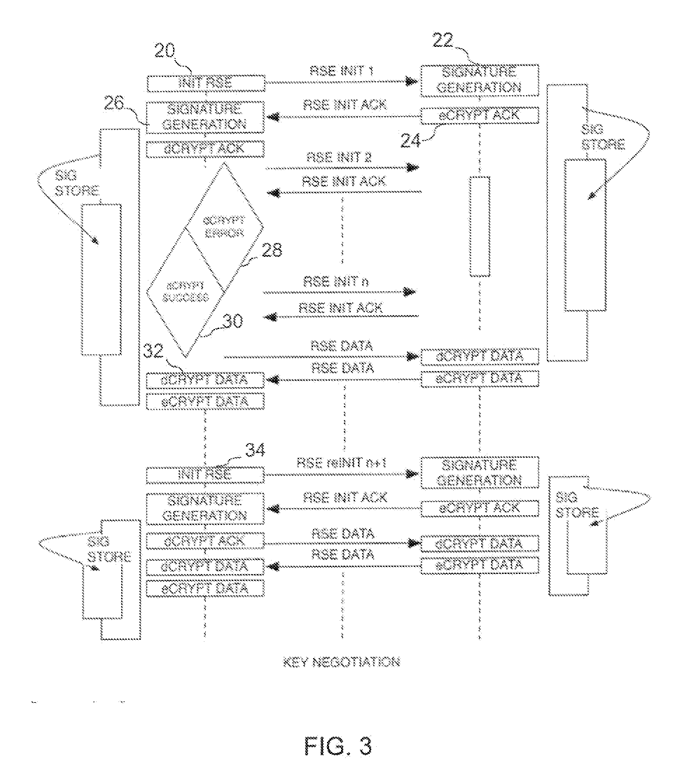

The key negotiation method is illustrated in FIG. 3. More particularly, node A initiates “Radio Scene Encrypted” communications with message ‘RSE_INIT_{—}1’ (see step 20 in FIG. 3). Node B uses the received message to generate the signatures in the manner describe hereinabove at step 22. Then, using the generated key (P_SIG) Node B replies to node A with an encrypted acknowledgment message ‘RSE_INIT_ACK’ at step 24. Node A generates signatures at block 26 based on the received message and uses P_SIG to decrypt the message at block 28. If decryption is successful (see block 30), the symmetric key has been established and Node A uses the key to encrypt and decrypt further data messages ‘RSE_DATA’ (e.g., see step 32). If decryption is not successful, RSE_INIT message is resent, until symmetric key is successfully established. Furthermore, key negotiation can be optionally repeated at random or predetermined intervals by either node through the RSE_reINIT message (e.g., see block 34).

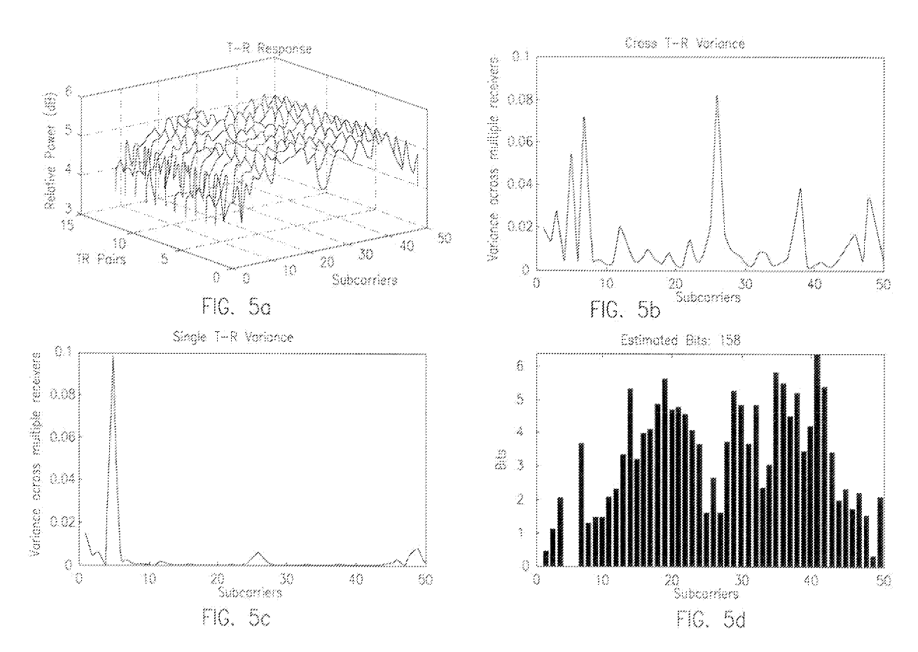

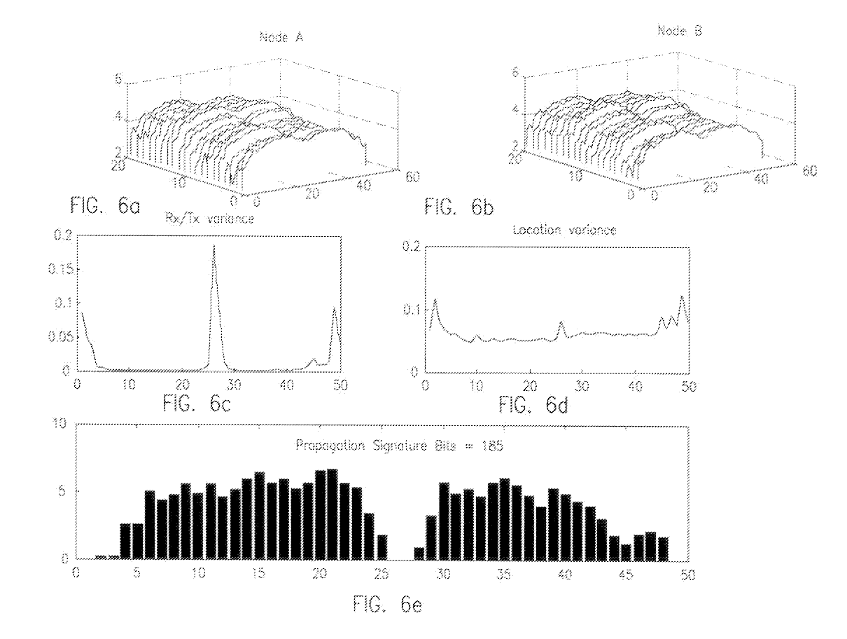

FIGS. 5a-5d and 6a-6e display experimental results derived from the use of a prototype to generate and analyze signatures towards the goal of determining the key-space achievable in a real world environment. FIG. 5a depicts the generated Transmit-Receive signatures after channel equalization for 12 different transceiver pairs under high SNR conditions. Multiple measurements are taken per transceiver pair. FIG. 5b illustrates the TR_{SIG} variance (Y-axis) per OFDM subcarrier (X-axis) across the multiple transceiver pairs. FIG. 5c illustrates the TR_{SIG} variance (Y-axis) per OFDM subcarrier (X-axis) across multiple estimates for a single transceiver pair, due to estimation process error. Through statistical analysis, ideal feature selection up to 158 bits of information can be extracted to differentiate transceivers, even from the same manufacturer. The results are presented in FIG. 5d as the estimated number of bits (Y-axis) per subcarrier (X-axis) achievable for the specific transceivers. Similar statistical analysis is used to evaluate the information bits available from the propagation signature. Packets were exchanged bi-directionally across 2 nodes at 20 varying relative locations in an indoor environment across different rooms. The measured propagation signatures from nodes A and B, after isolation of the transceiver impairments, are depicted in FIGS. 6a and 6b respectively. FIGS. 6c and 6d illustrate the measurement variance (Y-axis) per subcarrier (X-axis) across the bidirectional measurements and the varying locations respectively. FIG. 6e depicts the statistical analysis results of the estimated bits of information (Y-axis) per subcarrier (X-axis), suggesting that up to 185 bits of information can be extracted to generate symmetric keys across two communicating nodes. These experimental results suggest the availability of sufficient information bits for generating signatures and keys.

It will be understood that the embodiment described herein is merely exemplary and that a person skilled in the art may make many variations and modifications without departing from the spirit and scope of the invention. For instance, all such variations and modifications are intended to be included within the scope of the invention.

We claim:

1. A method for encryption/decryption and authentication during forward and reverse path communications for data between a transmitter frontend and a receiver frontend on a link between a first transceiver and a second transceiver, comprising the steps of:
determining a channel response having independent information bits for the link;
determining a propagation signature from said independent information bits extracted from said channel response, whereby said propagation signature is used as a symmetric key with which the data is encrypted/decrypted;
determining a transmit-receive frequency response having independent information bits for the forward path communications for the transmitter and receiver frontends;
determining a transmitter-receiver signature from said independent information bits extracted from said transmit-receiver frequency response for the forward path communications, whereby said transmitter-receiver signature is used by the receiver as an authentication mask for identifying the transmitter together with said propagation signature;
determining a transmit-receive frequency response having independent information bits for the reverse path communications for the transmitter and receiver frontends; and
determining a transmitter-receiver signature from said independent information bits extracted from said transmit-receiver frequency response for the reverse path communications, whereby said transmitter-receiver signature is used by the receiver as an authentication mask for identifying the transmitter together with said propagation signature.
